(19) United States
(12) Patent Application Publication
(10) Pub. No.: US 2026/0064240 A1
(43) Pub. Date: Mar. 5, 2026

(54) CONTENT DISPLAY METHOD, READABLE MEDIUM, AND ELECTRONIC DEVICE

(71) Applicant: Beijing Youzhuju Network Technology Co., Ltd., Beijing (CN)

(72) Inventors: Jiaqian ZHANG, Beijing (CN); Jinming ZHANG, Beijing (CN); Shengyan SHI, Beijing (CN); Jin BAI, Beijing (CN)

(21) Appl. No.: 19/296,175

(22) Filed: Aug. 11, 2025

(30) Foreign Application Priority Data
Aug. 27, 2024 (CN) 202411189191.0

(51) Int. Cl. G06F 3/04815; G06F 3/0484; G06F 16/9538; G06T 19/20

(52) U.S. Cl. CPC G06F 3/04815; G06F 3/0484; G06F 16/9538; G06T 19/20; G06T 2200/24; G06T 2219/2016

(57) ABSTRACT

The present disclosure relates to a content display method, an apparatus, a readable medium, an electronic device, and a program product. The content display method includes: displaying target content associated with a search keyword in response to a search operation based on the search keyword in a terminal device, the target content includes first main content and a background canvas, and the first main content is displayed with first background content in the background canvas as a background; and controlling the background canvas and the first main content to move along with a swipe operation on the target content in response to the swipe operation, to switch the first background content to second background content in the background canvas and switch the first main content to second main content, the second main content is displayed with the second background content as a background.

### CROSS-REFERENCE TO RELATED APPLICATION

This application claims the priority to and benefits of the Chinese Patent Application, No. 202411189191.0, which was filed on Aug. 27, 2024. The aforementioned patent application is hereby incorporated by reference in its entirety.

### TECHNICAL FIELD

The present disclosure relates to a content display method, an apparatus, a readable medium, an electronic device, and a program product.

### BACKGROUND

A search interface can accelerate a process of acquiring information by a user, and is crucial to interaction between the user and an application.

In the related art, search results are often displayed in a single display form, for example, a search result list is displayed, and preset content related to a search keyword is displayed at the top of a search result page. The display form of interface content is single, and the interface lacks interactivity, resulting in poor user experience.

### SUMMARY

The Summary is provided to introduce concepts in a simplified form that are described in detail in the following Detailed Description section. The Summary is not intended to identify key features or essential features of the claimed technical solutions, nor is it intended to be used to limit the scope of the claimed technical solutions.

In a first aspect, the present disclosure provides a content display method, the content display method including:
displaying target content associated with a search keyword in response to a search operation based on the search keyword in a terminal device, where the target content includes first main content and a background canvas, and the first main content is displayed with first background content in the background canvas as a background; and
controlling the background canvas and the first main content to move with a swipe operation on the target content in response to the swipe operation, to switch the first background content to second background content in the background canvas and switch the first main content to second body content, where the second main content is displayed with the second background content as a background.

In a second aspect, the present disclosure provides a content display apparatus, the content display apparatus including:
a display module, configured to display target content associated with a search keyword in response to a search operation based on the search keyword in a terminal device, where the target content includes first main content and a background canvas, and the first main content is displayed with first background content in the background canvas as a background; and
a switch module, configured to control the background canvas and the first main content to move with a swipe operation on the target content in response to the swipe operation, to switch the first background content to second background content in the background canvas and switch the first main content to second body content, where the second main content is displayed with the second background content as a background.

In a third aspect, the present disclosure provides a computer-readable medium having a computer program stored thereon, where the computer program, when executed by a processing apparatus, implements the steps of the method according to the first aspect.

In a fourth aspect, the present disclosure provides an electronic device, including:
a storage apparatus having a computer program stored thereon; and
a processing apparatus, configured to execute the computer program in the storage apparatus to implement the steps of the method according to the first aspect.

In a fifth aspect, the present disclosure provides a computer program product, including a computer program, where the computer program, when executed by a processor, implements the steps of the method according to the first aspect.

Features and advantages of the present disclosure will be described in detail in the following detailed description section.

### BRIEF DESCRIPTION OF DRAWINGS

The above and other features, advantages and aspects of the embodiments of the present disclosure will become more apparent when taken in conjunction with the drawings and with reference to the following detailed description. Throughout the drawings, the same or similar reference numerals refer to the same or similar elements. It should be understood that the drawings are schematic and that parts and elements are not necessarily drawn to scale. In the drawings:

FIG. 1 is a schematic diagram of a search interface according to an exemplary embodiment of the present disclosure;

FIG. 2 is a flowchart of a content display method according to an exemplary embodiment of the present disclosure;

FIG. 3 is a schematic diagram of interface switching of a swipe operation according to an exemplary embodiment of the present disclosure;

FIG. 4 is a schematic diagram of display of a plurality of display objects according to an exemplary embodiment of the present disclosure;

FIG. 5 is a schematic diagram of switching display of a plurality of display objects according to an exemplary embodiment of the present disclosure;

FIG. 6 is a structural block diagram of a content display apparatus according to an exemplary embodiment of the present disclosure; and

FIG. 7 is a schematic structural diagram of an electronic device according to an exemplary embodiment of the present disclosure.

### DETAILED DESCRIPTION

The embodiments of the present disclosure will be described in more detail below with reference to the drawings. While some embodiments of the present disclosure are shown in the drawings, it should be understood that the present disclosure may be implemented in various forms and should not be construed as limited to the embodiments set forth herein, and these embodiments are provided for a more thorough and complete understanding of the present disclosure. It should be understood that the drawings and embodiments of the present disclosure are only for exemplary purposes, and are not intended to limit the scope of the present disclosure.

It should be understood that the various steps recited in the method implementations of the present disclosure may be performed in a different order and/or in parallel. In addition, the method implementations may include additional steps and/or omit to perform illustrated steps. The scope of the present disclosure is not limited in this respect.

As used herein, the term “include/comprise” and variations thereof are open-ended inclusions, that is, “include/comprise but not limited to”. The term “based on” is “based at least in part on”. The term “one embodiment” means “at least one embodiment”: the term “another embodiment” means “at least one additional embodiment”: the term “some embodiments” means “at least some embodiments”. Related definitions of other terms will be given in the following description.

It should be noted that concepts such as “first” and “second” mentioned in the present disclosure are only used to distinguish between different apparatuses, modules, or units, and are not used to limit the order of functions performed by these apparatuses, modules, or units or the interdependence between them.

It should be noted that modifications of “one” and “a plurality of” mentioned in the present disclosure are illustrative rather than restrictive, and those skilled in the art should understand that they should be understood as “one or more” unless the context clearly indicates otherwise.

The names of messages or information exchanged between a plurality of apparatuses in the implementations of the present disclosure are only used for illustrative purposes, and are not intended to limit the scope of these messages or information.

It can be understood that before using the technical solutions disclosed in the embodiments of the present disclosure, users should be informed of the type, use scope, use scene, etc. of personal information involved in the present disclosure in an appropriate manner and their authorization should be obtained in accordance with relevant laws and regulations.

For example, in response to receiving an active request from a user, prompt information is sent to the user to explicitly prompt the user that the operation requested to be performed will require the acquisition and use of the user's personal information. Thus, the user can independently choose whether to provide personal information to software or hardware such as an electronic device, an application, a server, or a storage medium that performs the operation of the technical solution of the present disclosure according to the prompt information.

As an optional but non-restrictive implementation, the manner of sending the prompt information to the user in response to receiving the active request from the user may be, for example, a pop-up window, and the prompt information may be presented in the pop-up window in a text form. In addition, the pop-up window may further carry a selection control for the user to select “agree” or “disagree” to provide personal information to the electronic device.

It can be understood that the above process of notifying and obtaining the user's authorization is only illustrative, and does not constitute a limitation on the implementations of the present disclosure, and other manners that meet relevant laws and regulations may also be applied to the implementations of the present disclosure.

At the same time, it can be understood that the data involved in the technical solution (including but not limited to the data itself, the acquisition or use of the data) should comply with the requirements of corresponding laws, regulations and related regulations.

As shown in FIG. 1, when a search keyword is entered in a search interface for searching, search results are often displayed in a single display form. Taking a search keyword as a product keyword related to a product as an example, store information, a product list, and other content associated with the product keyword are usually displayed in the search interface, and preset content associated with the product is displayed at the top of the search interface in a fixed style, such as a picture introducing the product. The display form of the interface content is single, which cannot meet the content display requirements of the content publisher, and the interface lacks interactivity, resulting in poor user experience.

In view of this, the present disclosure provides a content display method, an apparatus, a readable medium, an electronic device, and a program product to solve the above technical problem. It should be noted that the content display method provided in the present disclosure can be applied not only to the above product search scenario, but also to other search scenarios, which is not limited by the present disclosure.

The embodiments of the present disclosure will be further explained and described below with reference to the drawings.

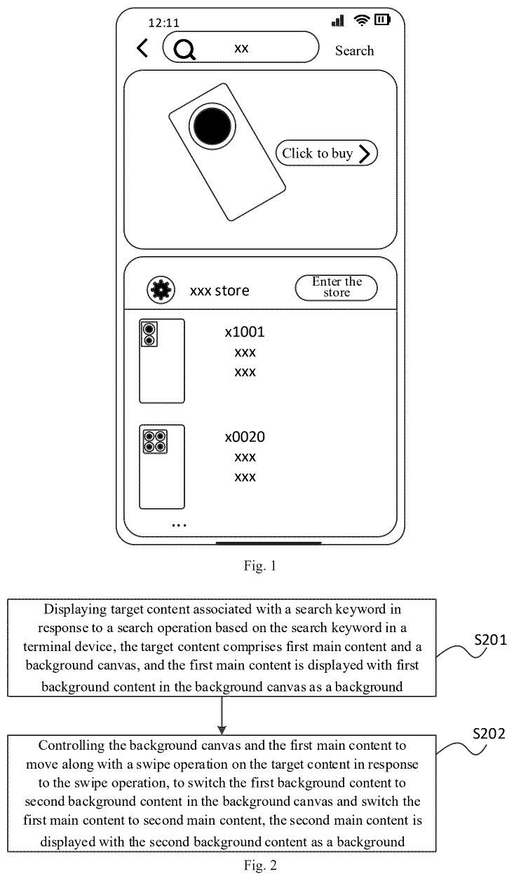

FIG. 2 is a flowchart of a content display method according to an exemplary embodiment of the present disclosure. Referring to FIG. 2, the method may include the following steps.

S201: displaying target content associated with a search keyword in response to a search operation based on the search keyword in a terminal device, the target content includes first main content and a background canvas, and the first main content is displayed with first background content in the background canvas as a background.

In a possible implementation, displaying the target content associated with the search keyword in response to the search operation based on the search keyword in the terminal device includes: displaying the target content associated with the search keyword in full screen in the terminal device in response to the search operation based on the search keyword in the terminal device; and/or, displaying the target content that is in a three-dimensional form and is associated with the search keyword in in response to the search operation based on the search keyword in the terminal device.

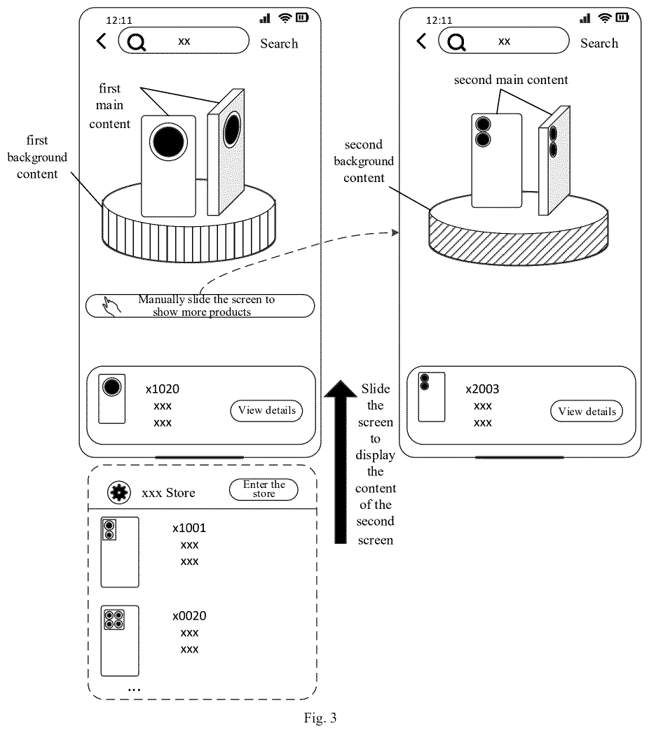

Exemplarily, referring to FIG. 3, in response to the search operation based on the search keyword, first content associated with the search keyword may be displayed in full screen on a first screen of a search interface. Taking the search keyword as a product keyword related to a product, such as a product name and a product brand related to the product, for example, the target content includes preset content related to the product and the background canvas displayed in full screen, so as to achieve a page effect of immersive display. The preset content may be preset product content, such as a two-dimensional plane or three-dimensional product picture, etc., which is not limited by the present disclosure.

It is worth noting that the present disclosure does not limit the content format of the main content, which may be, for example, a picture, a dynamic image, a video, or other formats, and may be specifically set according to requirements.

Compared with the display mode shown in FIG. 1, the present disclosure displays search results related to the search keyword on the second screen, which can increase the display area of the target content, and is also convenient for displaying more display objects subsequently, which can not only carry more display content, but also enrich the display form of the display content in the search interface. It can not only improve the user's browsing experience, but also meet the content display requirements of the content publisher.

Certainly, the size of the display area of the first content may also not be limited, which may be specifically set according to requirements, and the present disclosure does not limit this.

S202: controlling the background canvas and the first main content to move along with a swipe operation on the target content in response to the swipe operation, to switch the first background content to second background content in the background canvas and switch the first main content to second main content, the second main content is displayed with the second background content as a background.

Exemplarily, as shown in FIG. 3, in response to the swipe operation on the target content, the second main content is displayed with the second background content as a background, and then the third main content may be displayed with the third background content as a background through sliding, and so on, and so forth. In addition, in other possible implementations, the next main content may be automatically switched and displayed after a preset duration, which may be specifically set according to requirements, and the present disclosure does not limit this.

It should be noted that when the first main content is two-dimensional plane content, the swipe operation may be a swipe operation on the first main content, or may be a swipe operation on the first background content. When the first main content is three-dimensional stereo content, a display angle of the first main content may be changed by means of swiping the first main content, and then the second main content is displayed with the second background content as a background through the swipe operation on the first background content. It may be specifically set according to requirements, and the present disclosure does not limit this.

Exemplarily, taking the search keyword as a product keyword as an example, the first content body and the second content body may be different product objects related to the product keyword, for example, the first main content may be a newly released or promoted product object, or a product object purchased or liked by a user, and the second main content and the first main content may be different product objects of the same category, or different product objects under the same brand, which may be specifically set according to requirements, and the present disclosure does not limit this.

Exemplarily, continuing to refer to FIG. 3, the first background content and the second background content may be the same or different, and specific display forms may also be set according to requirements, for example, the first background content and the second background content are different areas of the same background canvas, and a card-style background, a booth-style background, etc. may also be added. In addition, prompt information of the swipe operation may be displayed synchronously when the first main content is displayed, which may be specifically set according to requirements, and the present disclosure does not limit this. Therefore, the content display form of the interface can be enriched, thereby improving the user's visual experience.

In a possible implementation, the first main content includes a first display object and a second display object, and correspondingly, the second main content includes a third display object and a fourth display object.

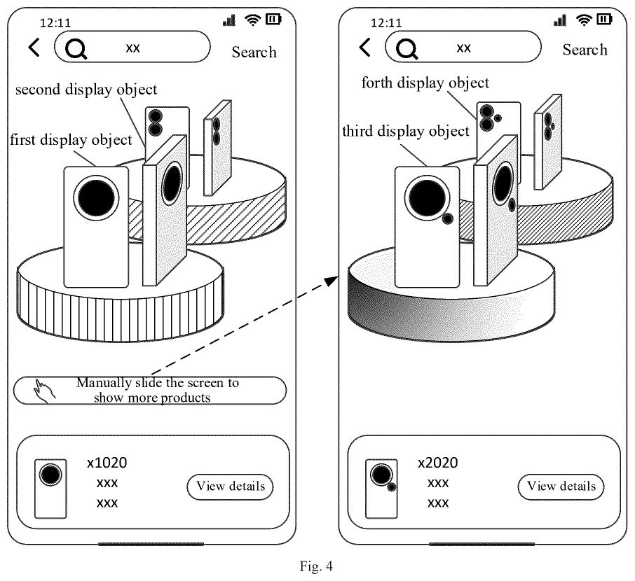

Exemplarily, referring to FIG. 4, one or more display objects may be displayed on the interface at a time, and different display objects displayed at the same time may be displayed with different display backgrounds, which may be specifically set according to requirements, and the present disclosure does not limit this. In this way, more content can be displayed at a time, the display space of the interface is fully utilized, and the content display efficiency of the interface is improved.

By means of the above method, the background canvas and the first main content can be controlled to move in response to an interactive operation of a user, so that the first main content is switched to the second main content, which is convenient for the user to browse and compare different content, and can improve not only interface interaction capability but also content display efficiency, thereby improving the user's browsing experience.

In a possible implementation, the first main content includes a first display object and a second display object, the first display object is displayed in a first style, and the second display object is displayed in a second style. The content display method further includes: controlling the second display object to be displayed in the first style and controlling the first display object to be displayed in the second style in response to a trigger operation on the second display object.

Exemplarily, as shown in FIG. 4, the display styles of the first display object and the second display object are different, which may be a difference in display position, display size, or display background, and may be specifically set according to requirements, and the present disclosure does not limit this. Taking the difference in display position as an example, the first display object and the second display object may be displayed in a front-back distribution, a left-right distribution, an up-down distribution, etc., which is not limited by the present disclosure. Therefore, it is convenient for the user to distinguish between the primary object and the secondary object, and perform the trigger operation of switching the display object.

It should be noted that the display style of one or more dimensions may be switched during switching display, for example, only the display size is changed, or the display size and the display position are changed at the same time, which may be specifically set according to requirements, and the present disclosure does not limit this.

In a possible implementation, a display size of the first display object is greater than a display size of the second display object; and controlling the second display object to be displayed in the first style and controlling the first display object to be displayed in the second style in response to the trigger operation on the second display object includes: enlarging and displaying the second display object and reducing and displaying the first display object in response to the trigger operation on the second display object.

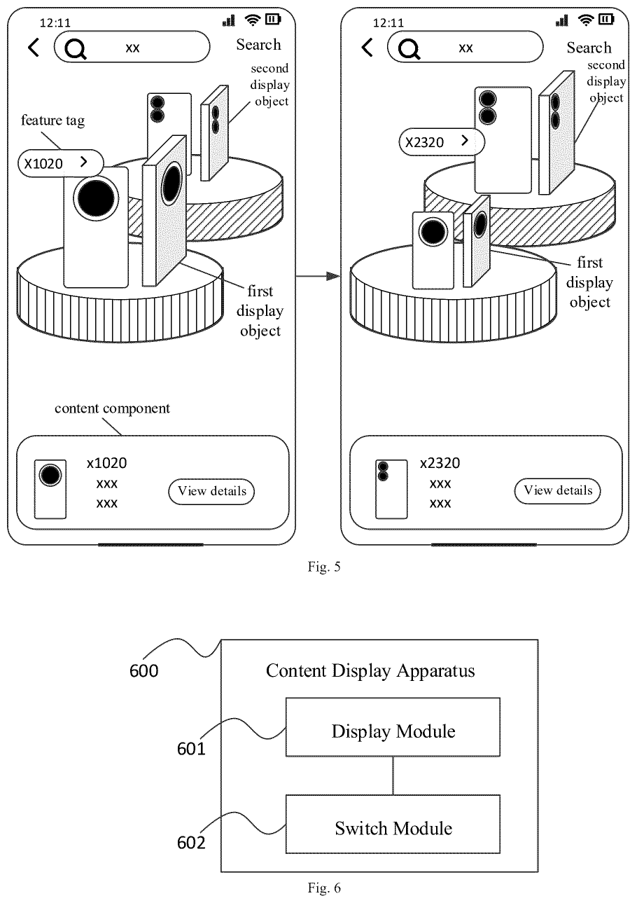

Exemplarily, as shown in FIG. 5, the display size of the first display object is greater than the display size of the second display object, and in response to the trigger operation on the second display object, the display styles of the first display object and the second display object are switched, that is, the second display object is enlarged and displayed, and the first display object is reduced and displayed, so that the primary and secondary display of the first display object and the second display object in the interface can be changed, the display effect of the display objects is enhanced, and the user can learn the detailed features of different display objects more intuitively. The trigger operation may be a click operation, a long press operation, or the like, which is not limited by the present disclosure.

In a possible implementation, the first display object is displayed and associated with a feature tag that is displayed, the second display object is displayed and associated with a feature tag that is not displayed, and the feature tag is at least used to display name information of an associated display object; that is the first display object is displayed and a feature tag associated with the first display object is displayed, the second display object is displayed and a feature tag associated with the second display object is not displayed. Controlling the second display object to be displayed in the first style and controlling the first display object to be displayed in the second style in response to the trigger operation on the second display object includes: displaying the feature tag associated with the second display object and canceling displaying the feature tag associated with the first display object in response to the trigger operation on the second display object.

Exemplarily, as shown in FIG. 5, when the first display object is mainly displayed on the interface, the first display object is displayed and associated with the feature tag that is displayed, and the second display object is displayed and associated with the feature tag that is not displayed. In response to the trigger operation on the second display object, that is, when the interface is switched to mainly display the second display object, the feature tag associated with the second display object is displayed, and the feature tag associated with the first display object is cancelled from being displayed. Therefore, more content can be displayed on the interface at the same time, and the content display efficiency of the interface is improved.

It should be noted that the feature tag may be identification information, name information, description information, attribute information, etc. of the display object, for example, taking the display object as a product object as an example, content such as a product name, a product attribute, a product price, etc. of the product object may be displayed, which may be specifically set according to requirements, and the present disclosure does not limit this.

In addition, the display form and display position of the feature tag may also be set according to requirements, for example, a semi-transparent mask may be displayed at a position around the associated display object. In addition, the feature tag may also have interactive capabilities, for example, by triggering the feature tag, it is possible to jump to a landing page associated with the associated display object, such as a product details page for the product object, etc., which is not limited by the present disclosure.

In other possible implementations, tag information of the first display object and the second display object may be displayed at the same time, for example, when the first display object is reduced and displayed, the tag information associated with the first display object is reduced and displayed, and the second display object and the tag information associated with the second display object are enlarged and displayed, which may be specifically set according to requirements, and the present disclosure does not limit this.

In a possible implementation, the first display object is displayed and associated with a content component that is displayed, the second display object is not displayed and associated with a content component that is not displayed, the content component is used to display feature information and/or an interactive control of a target display object that is associated with the content component, and the interactive control is used to trigger to display a target page associated with the target display object; that is the first display object is displayed and a content component associated with the first display object is displayed, the second display object is displayed and a content component associated with the second display object is not displayed. Controlling the second display object to be displayed in the first style and controlling the first display object to be displayed in the second style in response to the trigger operation on the second display object includes: displaying the content component associated with the second display object and canceling displaying the content component associated with the first display object in response to the trigger operation on the second display object.

Exemplarily, as shown in FIG. 5, when the first display object is mainly displayed on the interface, the first display object is displayed and associated with a content component that is displayed, and the second display object is displayed and associated with a content component that is not displayed. In response to the trigger operation on the second display object, that is, when the interface is switched to mainly display the second display object, the content component associated with the second display object is displayed, and the content component associated with the first display object is cancelled from being displayed. Therefore, more content can be displayed on the interface at the same time, and the content display efficiency of the interface is improved.

Exemplarily, the content component is used to display feature information of the associated target display object, for example, taking the display object as a product object as an example, content such as a product name, a product attribute, a product price, etc. of the product object may be displayed, which may be specifically set according to requirements, and the present disclosure does not limit this. And/or, the content component is used to display an interactive control of the associated target display object, and the interactive control is used to trigger to display a target page associated with the target display object, such as a product details page for the product object, etc., which is not limited by the present disclosure.

It should be noted that as shown in FIG. 4, when the second content body is switched and displayed in response to the user's swipe operation, the content component is also switched to the content component associated with the second content body.

It should be understood that the main content, the background content, the feature tag, the prompt information, the content component, etc. in the drawings provided by the embodiments of the present disclosure are all exemplary descriptions, and may be specifically set according to requirements. For example, the content component and the feature tag may be displayed at the same time, or one of them may be selected for display, which is not limited by the present disclosure.

By means of the above method, in combination with the multi-object booth canvas with interactive capabilities, by optimizing the interaction mode of horizontal swiping of the interface and the switching effect of clicking on the booth object, more display objects and the detailed features of the currently displayed primary object can be intuitively displayed. It is convenient for the user to browse and compare different display objects, the interaction between the user and the interface is enhanced, and the user's browsing experience is improved.

Based on the same concept, an embodiment of the present disclosure further provides a content display apparatus. As shown in FIG. 6, the content display apparatus 600 may include:
a display module 601, configured to display target content associated with a search keyword in response to a search operation based on the search keyword in a terminal device, where the target content includes first main content and a background canvas, and the first main content is displayed with first background content in the background canvas as a background; and
a switch module 602, configured to control the background canvas and the first main content to move with a swipe operation on the target content in response to the swipe operation, to switch the first background content to second background content in the background canvas and switch the first main content to second main content, where the second main content is displayed with the second background content as a background.

By means of the above apparatus, a background canvas and first main content can be controlled to move in response to an interactive operation of a user, so that the first main content is switched to the second main content, which is convenient for the user to browse and compare different content, and can improve not only interface interaction capability but also content display efficiency, thereby improving the user's browsing experience.

Optionally, the first main content includes a first display object and a second display object, the first display object is displayed in a first style, and the second display object is displayed in a second style. The content display apparatus 600 further includes:
a control module, configured to control the second display object to be displayed in the first style and control the first display object to be displayed in the second style in response to a trigger operation on the second display object.

Optionally, a display size of the first display object is greater than a display size of the second display object; and
the control module is configured to enlarge and display the second display object and reduce and display the first display object in response to the trigger operation on the second display object.

Optionally, the first display object is displayed and a feature tag associated with the first display object is displayed, the second display object is displayed and a feature tag associated with the second display object is not displayed, and the feature tag is at least used to display name information of an associated display object; and
the control module is configured to:
display the feature tag associated with the second display object and cancel displaying the feature tag associated with the first display object in response to the trigger operation on the second display object.

Optionally, the first display object is displayed and a content component associated with the first display object is displayed, the second display object is displayed and a content component associated with the second display object is not displayed, the content component is used to display feature information and/or an interactive control of a target display object that is associated with the content component, and the interactive control is used to trigger to display a target page associated with the target display object; and
the control module is configured to:
display the content component associated with the second display object and cancel displaying the content component associated with the first display object in response to the trigger operation on the second display object.

Optionally, the display module 601 is configured to:
display the target content associated with the search keyword in full screen in the terminal device in response to the search operation based on the search keyword in the terminal device; and/or,
display the target content that is in a three-dimensional form and is associated with the search keyword in response to the search operation based on the search keyword in the terminal device.

Optionally, the first main content includes the first display object and the second display object, and correspondingly, the second main content includes the third display object and the fourth display object.

Based on the same concept, an embodiment of the present disclosure further provides a computer-readable medium having a computer program stored thereon, where the computer program, when executed by a processing apparatus, implements the steps of the above content display method.

Based on the same concept, an embodiment of the present disclosure further provides an electronic device, which may include:
a storage apparatus having a computer program stored thereon; and
a processing apparatus, configured to execute the computer program in the storage apparatus to implement the steps of the above content display method.

Based on the same concept, an embodiment of the present disclosure further provides a computer program product, including a computer program, where the computer program, when executed by a processor, implements the steps of the above content display method.

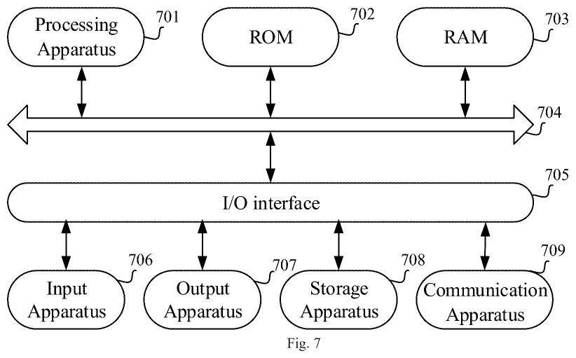

Reference is made to FIG. 7 below, which illustrates a schematic structural diagram of an electronic device 700 suitable for implementing the embodiments of the present disclosure. The terminal device in the embodiments of the present disclosure may include, but is not limited to, a mobile terminal such as a mobile phone, a notebook, a digital broadcast receiver, a personal digital assistant (PDA), a tablet computer, a portable multimedia player (PMP), a vehicle-mounted terminal (for example, a vehicle-mounted navigation terminal), and a fixed terminal such as a digital TV, a desktop computer, and the like. The electronic device shown in FIG. 7 is only an example and should not impose any limitation on the function and usage scope of the embodiments of the present disclosure.

As shown in FIG. 7, the electronic device 700 may include a processing apparatus (for example, a central processing unit, a graphics processor, etc.) 701, which may perform various appropriate actions and processing according to a program stored in a read-only memory (ROM) 702 or a program loaded from a storage apparatus 708 into a random-access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 such as a touchscreen, a touchpad, a keyboard, a mouse, a camera, a microphone, an accelerometer, and a gyroscope; an output apparatus 707 such as a liquid crystal display (LCD), a speaker, and a vibrator; a storage apparatus 708 such as a magnetic tape and a hard disk; and a communication apparatus 709. The communication apparatus 709 may allow the electronic device 700 to perform wireless or wired communication with other devices to exchange data. While FIG. 7 shows the electronic device 700 having various apparatuses, it should be understood that not all of the illustrated apparatuses are necessarily implemented or provided. Alternatively, more or fewer apparatuses may be implemented or provided.

In particular, according to the embodiments of the present disclosure, the processes described above with reference to the flowcharts may be implemented as computer software programs. For example, an embodiment of the present disclosure includes a computer program product, which includes a computer program carried on a non-transitory computer-readable medium, and the computer program includes program code for executing the method shown in the flowcharts. In such an embodiment, the computer program may be downloaded and installed from the network through the communication apparatus 709, or installed from the storage apparatus 708, or installed from the ROM 702. When the computer program is executed by the processing apparatus 701, the above functions defined in the method of the embodiments of the present disclosure are executed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal that propagates in a baseband or as a part of a carrier and carries computer-readable program code. The data signal propagating in this manner may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program code contained on the computer-readable medium may be transmitted by any suitable medium, including but not limited to an electrical wire, an optical cable, RF (radio frequency), or any suitable combination thereof.

In some implementations, any currently known or future developed network protocol such as the HyperText Transfer Protocol (HTTP) may be used for communication, and may be interconnected with any form or medium of digital data communication (for example, a communication network). Examples of the communication network include a local area network (“LAN”), a wide area network (“WAN”), an internet (for example, the Internet), and a peer-to-peer network (for example, an ad hoc network), as well as any currently known or future developed network.

The above computer-readable medium may be included in the above electronic device, or may exist alone without being assembled into the electronic device.

The above computer-readable medium carries one or more programs which, when executed by the electronic device, cause the electronic device to: display target content associated with a search keyword in response to a search operation based on the search keyword in a terminal device, where the target content includes first main content and a background canvas, and the first main content is displayed with first background content in the background canvas as a background; and control the background canvas and the first main content to move with a swipe operation on the target content in response to the swipe operation, to switch the first background content to second background content in the background canvas and switch the first main content to second main content, where the second main content is displayed with the second background content as a background.

The computer program codes for performing the operations of the present disclosure may be written in one or more programming languages or a combination thereof. The above-mentioned programming languages include object-oriented programming languages such as Java, Smalltalk, C++, and also include conventional procedural programming languages such as “C” or similar programming languages. The program code may be executed entirely on the user's computer, partly on the user's computer, as a stand-alone software package, partly on the user's computer and partly on a remote computer, or entirely on the remote computer or server. In the scenario involving the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a part of codes, including one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules involved in the embodiments described in the present disclosure may be implemented in software or hardware. The name of a module does not constitute a limitation of the module itself under certain circumstances.

The functions described herein above may be performed, at least in part, by one or more hardware logic components. For example, without limitation, available exemplary types of hardware logic components include: a field-programmable gate array (FPGA), an application-specific integrated circuit (ASIC), an application-specific standard product (ASSP), a system on a chip (SOC), a complex programmable logical device (CPLD), etc.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the foregoing. More specific examples of the machine-readable storage medium would include an electrical connection having one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The above description is merely preferred embodiments of the present disclosure and the explanation of the applied technical principles. Those skilled in the art should understand that the disclosure scope involved in the present disclosure is not limited to the technical solutions formed by the specific combination of the above technical features, and should also cover other technical solutions formed by any combination of the above technical features or equivalent features thereof without departing from the above disclosed concept, for example, a technical solution formed by replacing the above features with technical features with similar functions disclosed in the present disclosure (but not limited to).

In addition, although various operations are depicted in a specific order, this should not be understood as requiring these operations to be performed in the specific order shown or in a sequential order. Under certain circumstances, multitasking and parallel processing may be advantageous. Likewise, although the above discussion contains several specific implementation details, these should not be construed as limiting the scope of the present disclosure. Certain features that are described in the context of separate embodiments may also be implemented in a single embodiment in combination. Conversely, various features described in the context of a single embodiment may also be implemented in multiple embodiments individually or in any suitable sub-combination.

Although the subject matter has been described in language specific to structural features and/or method logical actions, it should be understood that the subject matter defined in the appended claims is not necessarily limited to the specific features or actions described above. On the contrary, the specific features and actions described above are only exemplary forms for implementing the claims. Regarding the apparatus in the above embodiments, the specific manners in which the respective modules perform operations have been described in detail in the embodiments related to the method, and will not be described in detail here.

1. A content display method, comprising:
displaying target content associated with a search keyword in response to a search operation based on the search keyword in a terminal device, wherein the target content comprises first main content and a background canvas, and the first main content is displayed with first background content in the background canvas as a background; and
controlling the background canvas and the first main content to move along with a swipe operation on the target content in response to the swipe operation, to switch the first background content to second background content in the background canvas and switch the first main content to second main content, wherein the second main content is displayed with the second background content as a background.

2. The content display method according to claim 1, wherein the first main content comprises a first display object and a second display object, the first display object is displayed in a first style, and the second display object is displayed in a second style; and the content display method further comprises:
controlling the second display object to be displayed in the first style and controlling the first display object to be displayed in the second style in response to a trigger operation on the second display object.

3. The content display method according to claim 2, wherein a display size of the first display object is greater than a display size of the second display object; and
the controlling the second display object to be displayed in the first style and controlling the first display object to be displayed in the second style in response to a trigger operation on the second display object comprises:
enlarging and displaying the second display object and reducing and displaying the first display object in response to the trigger operation on the second display object.

4. The content display method according to claim 2, wherein the first display object is displayed and a feature tag associated with the first display object is displayed, the second display object is displayed and a feature tag associated with the second display object is not displayed, and the feature tag is at least used to display name information of an associated display object; and
the controlling the second display object to be displayed in the first style and controlling the first display object to be displayed in the second style in response to a trigger operation on the second display object comprises:
displaying the feature tag associated with the second display object and canceling displaying the feature tag associated with the first display object in response to the trigger operation on the second display object.

5. The content display method according to claim 2, wherein the first display object is displayed and a content component associated with the first display object is displayed, the second display object is displayed and a content component associated with the second display object is not displayed, the content component is used to display feature information and/or an interactive control of a target display object that is associated with the content component, and the interactive control is used to trigger to display a target page associated with the target display object; and
the controlling the second display object to be displayed in the first style and controlling the first display object to be displayed in the second style in response to a trigger operation on the second display object comprises:
displaying the content component associated with the second display object and canceling displaying the content component associated with the first display object in response to the trigger operation on the second display object.

6. The content display method according to claim 1, wherein the displaying target content associated with a search keyword in response to a search operation based on the search keyword in a terminal device comprises:
displaying the target content associated with the search keyword in full screen in the terminal device in response to the search operation based on the search keyword in the terminal device; and/or,
displaying the target content that is in a three-dimensional form and is associated with the search keyword in response to the search operation based on the search keyword in the terminal device.

7. The content display method according to claim 1, wherein the first main content comprises a first display object and a second display object, and correspondingly, the second main content comprises a third display object and a fourth display object.

8. A non-transitory computer-readable medium having a computer program stored thereon, wherein the computer program, when executed by a processing apparatus, implements the steps of a content display method, and the content display method comprises:
displaying target content associated with a search keyword in response to a search operation based on the search keyword in a terminal device, wherein the target content comprises first main content and a background canvas, and the first main content is displayed with first background content in the background canvas as a background; and
controlling the background canvas and the first main content to move along with a swipe operation on the target content in response to the swipe operation, to switch the first background content to second background content in the background canvas and switch the first main content to second main content, wherein the second main content is displayed with the second background content as a background.

9. The non-transitory computer-readable medium according to claim 8, wherein the first main content comprises a first display object and a second display object, the first display object is displayed in a first style, and the second display object is displayed in a second style; and the content display method further comprises:
controlling the second display object to be displayed in the first style and controlling the first display object to be displayed in the second style in response to a trigger operation on the second display object.

10. The non-transitory computer-readable medium according to claim 9, wherein a display size of the first display object is greater than a display size of the second display object; and
the controlling the second display object to be displayed in the first style and controlling the first display object to be displayed in the second style in response to a trigger operation on the second display object comprises:
enlarging and displaying the second display object and reducing and displaying the first display object in response to the trigger operation on the second display object.

11. The non-transitory computer-readable medium according to claim 9, wherein the first display object is displayed and a feature tag associated with the first display object is displayed, the second display object is displayed and a feature tag associated with the second display object is not displayed, and the feature tag is at least used to display name information of an associated display object; and
the controlling the second display object to be displayed in the first style and controlling the first display object to be displayed in the second style in response to a trigger operation on the second display object comprises:
displaying the feature tag associated with the second display object and canceling displaying the feature tag associated with the first display object in response to the trigger operation on the second display object.

12. The non-transitory computer-readable medium according to claim 9, wherein the first display object is displayed and a content component associated with the first display object is displayed, the second display object is displayed and a content component associated with the second display object is not displayed, the content component is used to display feature information and/or an interactive control of a target display object that is associated with the content component, and the interactive control is used to trigger to display a target page associated with the target display object; and
the controlling the second display object to be displayed in the first style and controlling the first display object to be displayed in the second style in response to a trigger operation on the second display object comprises:
displaying the content component associated with the second display object and canceling displaying the content component associated with the first display object in response to the trigger operation on the second display object.

13. The non-transitory computer-readable medium according to claim 8, wherein the displaying target content associated with a search keyword in response to a search operation based on the search keyword in a terminal device comprises:
displaying the target content associated with the search keyword in full screen in the terminal device in response to the search operation based on the search keyword in the terminal device; and/or,
displaying the target content that is in a three-dimensional form and is associated with the search keyword in response to the search operation based on the search keyword in the terminal device.

14. The non-transitory computer-readable medium according to claim 8, wherein the first main content comprises a first display object and a second display object, and correspondingly, the second main content comprises a third display object and a fourth display object.

15. An electronic device, comprising:
a storage apparatus having a computer program stored thereon; and
a processing apparatus, configured to execute the computer program in the storage apparatus to implement the steps of a content display method, and the method comprises:
displaying target content associated with a search keyword in response to a search operation based on the search keyword in a terminal device, wherein the target content comprises first main content and a background canvas, and the first main content is displayed with first background content in the background canvas as a background; and
controlling the background canvas and the first main content to move along with a swipe operation on the target content in response to the swipe operation, to switch the first background content to second background content in the background canvas and switch the first main content to second main content, wherein the second main content is displayed with the second background content as a background.

16. The electronic device according to claim 15, wherein the first main content comprises a first display object and a second display object, the first display object is displayed in a first style, and the second display object is displayed in a second style; and the content display method further comprises:
controlling the second display object to be displayed in the first style and controlling the first display object to be displayed in the second style in response to a trigger operation on the second display object.

17. The electronic device according to claim 16, wherein a display size of the first display object is greater than a display size of the second display object; and
the controlling the second display object to be displayed in the first style and controlling the first display object to be displayed in the second style in response to a trigger operation on the second display object comprises:
enlarging and displaying the second display object and reducing and displaying the first display object in response to the trigger operation on the second display object.

18. The electronic device according to claim 16, wherein the first display object is displayed and a feature tag associated with the first display object is displayed, the second display object is displayed and a feature tag associated with the second display object is not displayed, and the feature tag is at least used to display name information of an associated display object; and
the controlling the second display object to be displayed in the first style and controlling the first display object to be displayed in the second style in response to a trigger operation on the second display object comprises:
displaying the feature tag associated with the second display object and canceling displaying the feature tag associated with the first display object in response to the trigger operation on the second display object.

19. The electronic device according to claim 16, wherein the first display object is displayed and a content component associated with the first display object is displayed, the second display object is displayed and a content component associated with the second display object is not displayed, the content component is used to display feature information and/or an interactive control of a target display object that is associated with the content component, and the interactive control is used to trigger to display a target page associated with the target display object; and
the controlling the second display object to be displayed in the first style and controlling the first display object to be displayed in the second style in response to a trigger operation on the second display object comprises:
displaying the content component associated with the second display object and canceling displaying the content component associated with the first display object in response to the trigger operation on the second display object.

20. The electronic device according to claim 15, wherein the displaying target content associated with a search keyword in response to a search operation based on the search keyword in a terminal device comprises:
displaying the target content associated with the search keyword in full screen in the terminal device in response to the search operation based on the search keyword in the terminal device; and/or,
displaying the target content that is in a three-dimensional form and is associated with the search keyword in response to the search operation based on the search keyword in the terminal device.
